(19) United States
(12) Patent Application Publication
(10) Pub. No.: US 2006/0064499 A1
(43) Pub. Date: Mar. 23, 2006

(54) Information retrieval system including voice browser and data conversion server

(75) Inventors: Dipanshu Sharma, San Diego, CA (US); Sunil Kumar, San Diego, CA (US); Chandra Shekhar Kholia, San Diego, CA (US)

Correspondence Address: FISH & RICHARDSON, PC, P.O. BOX 1022, MINNEAPOLIS, MN, 55440-1022, US

(73) Assignee: V-Enable, Inc.

(21) Appl. No.: 11/264,293

(22) Filed: Oct. 31, 2005

Related U.S. Application Data
(63) Continuation of application No. 10/040,525, filed on Dec. 28, 2001.

(51) Int. Cl. G06F 15/16

(52) U.S. Cl. 709/230

(57) ABSTRACT

A method for retrieving content from one or more remote information sources is disclosed herein. The inventive method contemplates transmitting a user request over a communication link to a voice browser operative in accordance with a voice-based protocol. In response, a browsing request identifying a remote information source corresponding to the user request is generated. Content formatted in accordance with a predefined protocol is then retrieved from the remote information source in accordance with the browsing request. The retrieved content is converted into a file of information formatted in compliance with the voice-based protocol. A response is provided to the user request on the basis of the file of converted information.

### CROSS-REFERENCE TO RELATED APPLICATIONS

This application is related to copending U.S. patent application Ser. No. ______, entitled DATA CONVERSION SERVER FOR VOICE BROWSING SYSTEM.

### FIELD OF THE INVENTION

The present invention relates to the field of browsers used for accessing data in distributed computing environments and, in particular, to techniques for accessing such data using Web browsers controlled at least in part through voice commands.

### BACKGROUND OF THE INVENTION

As is well known, the World Wide Web, or simply “the Web”, is comprised of a large and continuously growing number of accessible Web pages. In the Web environment, clients request Web pages from Web servers using the Hypertext Transfer Protocol (“HTTP”). HTTP is a protocol which provides users access to files including text, graphics, images, and sound using a standard page description language known as the Hypertext Markup Language (“HTML”). HTML provides document formatting allowing the developer to specify links to other servers in the network. A Uniform Resource Locator (URL) defines the path to Web site hosted by a particular Web server.

The pages of Web sites are typically accessed using an HTML-compatible browser (e.g., Netscape Navigator or Internet Explorer) executing on a client machine. The browser specifies a link to a Web server and particular Web page using a URL. When the user of the browser specifies a link via a URL, the client issues a request to a naming service to map a hostname in the URL to a particular network IP address at which the server is located. The naming service returns a list of one or more IP addresses that can respond to the request. Using one of the IP addresses, the browser establishes a connection to a Web server. If the Web server is available, it returns a document or other object formatted according to HTML.

As Web browsers become the primary interface for access to many network and server services, Web applications in the future will need to interact with many different types of client machines including, for example, conventional personal computers and recently developed “thin” clients. Thin clients can range between 60 inch TV screens to handheld mobile devices. This large range of devices creates a need to customize the display of Web page information based upon the characteristics of the graphical user interface (“GUI”) of the client device requesting such information. Using conventional technology would most likely require that different HTML pages or scripts be written in order to handle the GUI and navigation requirements of each client environment.

Client devices differ in their display capabilities, e.g., monochrome, color, different color palettes, resolution, sizes. Such devices also vary with regard to the peripheral devices that may be used to provide input signals or commands (e.g., mouse and keyboard, touch sensor, remote control for a TV set-top box). Furthermore, the browsers executing on such client devices can vary in the languages supported, (e.g., HTML, dynamic HTML, XML, Java, JavaScript). Because of these differences, the experience of browsing the same Web page may differ dramatically depending on the type of client device employed.

The inability to adjust the display of Web pages based upon a client's capabilities and environment causes a number of problems. For example, a Web site may simply be incapable of servicing a particular set of clients, or may make the Web browsing experience confusing or unsatisfactory in some way. Even if the developers of a Web site have made an effort to accommodate a range of client devices, the code for the Web site may need to be duplicated for each client environment. Duplicated code consequently increases the maintenance cost for the Web site. In addition, different URLs are frequently required to be known in order to access the Web pages formatted for specific types of client devices.

In addition to being satisfactorily viewable by only certain types of client devices, content from Web pages has been generally been inaccessible to those users not having a personal computer or other hardware device similarly capable of displaying Web content. Even if a user possesses such a personal computer or other device, the user needs to have access to a connection to the Internet. In addition, those users having poor vision or reading skills are likely to experience difficulties in reading text-based Web pages. For these reasons, efforts have been made to develop Web browsers for facilitating non-visual access to Web pages for users that wish to access Web-based information or services through a telephone. Such non-visual Web browsers, or “voice browsers”, present audio output to a user by converting the text of Web pages to speech and by playing pre-recorded Web audio files from the Web. A voice browser also permits a user to navigate between Web pages by following hypertext links, as well as to choose from a number of pre-defined links, or “bookmarks” to selected Web pages. In addition, certain voice browsers permit users to pause and resume the audio output by the browser.

A particular protocol applicable to voice browsers appears to be gaining acceptance as an industry standard. Specifically, the Voice eXtensible Markup Language (“VoiceXML”) is a markup language developed specifically for voice applications useable over the Web, and is described at http://www.voicexml.org. VoiceXML defines an audio interface through which users may interact with Web content, similar to the manner in which the Hypertext Markup Language (“HTML”) specifies the visual presentation of such content. In this regard VoiceXML includes intrinsic constructs for tasks such as dialogue flow, grammars, call transfers, and embedding audio files.

Unfortunately, the VoiceXML standard generally contemplates that VoiceXML-compliant voice browsers interact exclusively with Web content of the VoiceXML format. This has limited the utility of existing VoiceXML-compliant voice browsers, since a relatively small percentage of Web sites include content formatted in accordance with VoiceXML. In addition to the large number of HTML-based Web sites, Web sites serving content conforming to standards applicable to particular types of user devices are becoming increasingly prevalent. For example, the Wireless Markup Language (“WML”) of the Wireless Application Protocol (“WAP”) (see, e.g., http://www.wapforum.org/) provides a standard for developing content applicable to wireless devices such as mobile telephones, pagers, and personal digital assistants. Some lesser-known standards for Web content include the Handheld Device Markup Language (“HDML”), and the relatively new Japanese standard Compact HTML.

The existence of myriad formats for Web content complicates efforts by corporations and other organizations make Web content accessible to substantially all Web users. That is, the ever increasing number of formats for Web content has rendered it time consuming and expensive to provide Web content in each such format. Accordingly, it would be desirable to provide a technique for enabling existing Web content to be accessed by standardized voice browsers, irrespective of the format of such content.

### SUMMARY OF THE INVENTION

In summary, the present invention relates to a method for retrieving information from remote information sources. The inventive method contemplates transmitting a user request over a communication link to a voice browser operative in accordance with a voice-based protocol. In response, a browsing request identifying a remote information source corresponding to the user request is generated. Content formatted in accordance with a predefined protocol is then retrieved from the remote information source in accordance with the browsing request. The retrieved content is converted into a file of information formatted in compliance with the voice-based protocol. A response is then provided to the user request on the basis of the file of converted information.

In another aspect, the present invention is directed to a system for retrieving information from remote information sources. The system includes a voice browser operating in accordance with a voice-based protocol. The voice browser is disposed to receive a user request transmitted over a communication link and to generate a browsing request in response to the user request. The system further includes a conversion server in communication with the voice browser. The conversion server includes a retrieval module for retrieving content from a remote information source in accordance with the browsing request. The retrieved content is formatted in accordance with a predefined protocol, and is converted by a conversion module of the conversion server into a file of converted information compliant with the voice-based protocol. The file of converted information is then provided to the voice browser through an interface of the conversion server.

### BRIEF DESCRIPTION OF THE DRAWINGS

For a better understanding of the nature of the features of the invention, reference should be made to the following detailed description taken in conjunction with the accompanying drawings, in which:

FIG. 1 provides a schematic diagram of a system for accessing Web content using a voice browser system in accordance with the present invention.

FIG. 2 shows a block diagram of a voice browser included within the system of FIG. 1.

FIG. 3 is a functional block diagram of a conversion server included within the voice browser system of the present invention.

FIG. 4 is a flow chart representative of operation of the system of the present invention in furnishing Web content to a requesting user.

FIG. 5 is a flow chart representative of operation of the system of the present invention in providing content from a proprietary database to a requesting user.

### DETAILED DESCRIPTION OF THE INVENTION

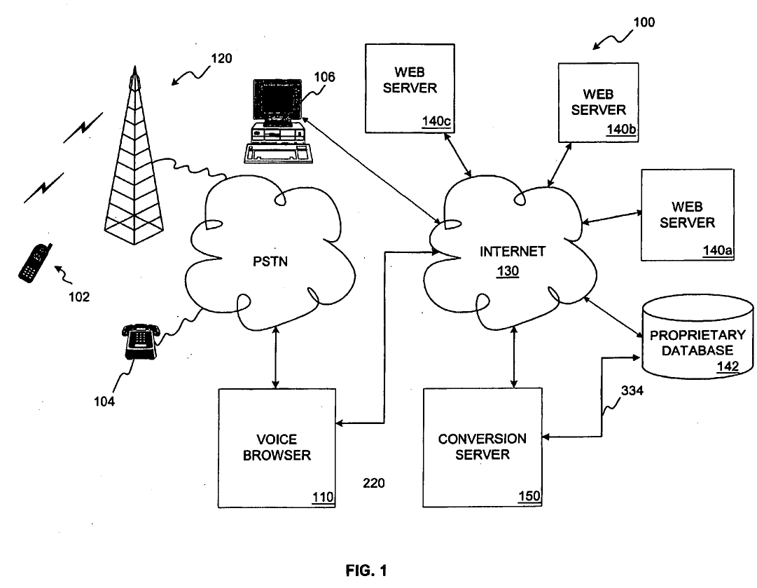

FIG. 1 provides a schematic diagram of a system 100 for accessing Web content using a voice browser in accordance with the present invention. The system 100 includes a telephonic subscriber unit 102 in communication with a voice browser 110 through a telecommunications network 120. In a preferred embodiment the voice browser 110 executes dialogues with a user of the subscriber unit 102 on the basis of document files comporting with a known speech mark-up language (e.g., VoiceXML). The voice browser 110 initiates, in response to requests for content submitted through the subscriber unit 102, the retrieval of information forming the basis of certain such document files from remote information sources. Such remote information sources may comprise, for example, Web servers 140 and one or more databases represented by proprietary database 142.

As is described hereinafter, the voice browser 110 initiates such retrieval by issuing a browsing request either directly to the applicable remote information source or to a conversion server 150. In particular, if the request for content pertains to a remote information source operative in accordance with the protocol applicable to the voice browser 110 (e.g., VoiceXML), then the voice browser 110 issues a browsing request directly to the remote information source of interest. For example, when the request for content pertains to a Web site formatted consistently with the protocol of the voice browser 110, a document file containing such content is requested by the voice browser 110 via the Internet 130 directly from the Web server 140 hosting the Web site of interest. On the other hand, when a request for content issued through the subscriber unit 102 identifies a Web site formatted inconsistently with the voice browser 110, the voice browser 110 issues a corresponding browsing request to a conversion server 150. In response, the conversion server 150 retrieves content from the Web server 140 hosting the Web site of interest and converts this content into a document file compliant with the protocol of the voice browser 110. The converted document file is then provided by the conversion server 150 to the voice browser 110, which then uses this file to effect a dialogue conforming to the applicable voice-based protocol with the user of subscriber unit 102. Similarly, when a request for content identifies a proprietary database 142, the voice browser 110 issues a corresponding browsing request to the conversion server 150. In response, the conversion server 150 retrieves content from the proprietary database 142 and converts this content into a document file compliant with the protocol of the voice browser 110. The converted document file is then provided to the voice browser 110 and used as the basis for carrying out a dialogue with the user of subscriber unit 102.

As shown in FIG. 1, the subscriber unit 102 is in communication with the voice browser 110 via the telecommunications network 120. The subscriber unit 102 has a keypad (not shown) and associated circuitry for generating Dual Tone MultiFrequency (DTMF) tones. The subscriber unit 102 transmits DTMF tones to, and receives audio output from, the voice browser 110 via the telecommunications network 120. In FIG. 1, the subscriber unit 102 is exemplified with a mobile station and the telecommunications network 120 is represented as including a mobile communications network and the Public Switched Telephone Network (“PSTN”). However, the voice-based information retrieval services offered by the system 100 can be accessed by subscribers through a variety of other types of devices and networks. For example, the voice browser 110 may be accessed through the PSTN from, for example, a stand-alone telephone 104 (either analog or digital), or from a node on a PBX (not shown). In addition, a personal computer 106 or other handheld or portable computing device disposed for voice over IP communication may access the voice browser 110 via the Internet 130.

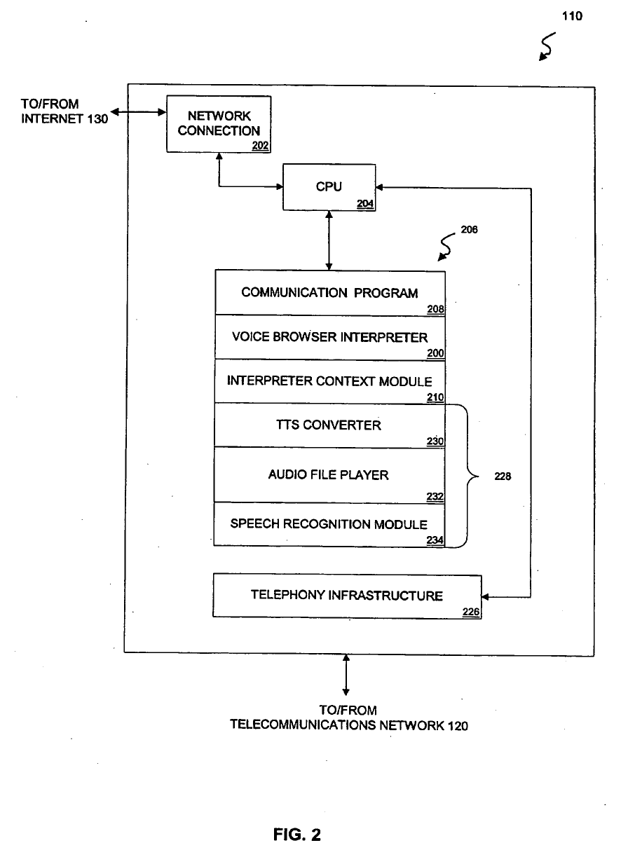

FIG. 2 shows a block diagram of the voice browser 110. The voice browser 110 includes certain standard server computer components, including a network connection device 202, a CPU 204 and memory (primary and/or secondary) 206. The voice browser 110 also includes telephony infrastructure 226 for effecting communication with telephony-based subscriber units (e.g., the mobile subscriber unit 102 and landline telephone 104). As is described below, the memory 206 stores a set of computer programs to implement the processing effected by the voice browser 110. One such program stored by memory 206 comprises a standard communication program 208 for conducting standard network communications via the Internet 130 with the conversion server 150 and any subscriber units operating in a voice over IP mode (e.g., personal computer 106).

As shown, the memory 206 also stores a voice browser interpreter 200 and an interpreter context module 210. In response to requests from, for example, subscriber unit 102 for Web or proprietary database content formatted inconsistently with the protocol of the voice browser 110, the voice browser interpreter 200 initiates establishment of a communication channel via the Internet 130 with the conversion server 150. The voice browser 110 then issues, over this communication channel and in accordance with conventional Internet protocols (i.e., HTTP and TCP/IP), browsing requests to the conversion server 150 corresponding to the requests for content submitted by the requesting subscriber unit. The conversion server 150 retrieves the requested Web or proprietary database content in response to such browsing requests and converts the retrieved content into document files in a format (e.g., VoiceXML) comporting with the protocol of the voice browser 110. The converted document files are then provided to the voice browser 110 over the established Internet communication channel and utilized by the voice browser interpreter 200 in carrying out a dialogue with a user of the requesting unit. During the course of this dialogue the interpreter context module 210 uses conventional techniques to identify requests for help and the like which may be made by the user of the requesting subscriber unit. For example, the interpreter context module 210 may be disposed to identify predefined “escape” phrases submitted by the user in order to access menus relating to, for example, help functions or various user preferences (e.g., volume, text-to-speech characteristics).

Referring to FIG. 2, audio content is transmitted and received by telephony infrastructure 226 under the direction of a set of audio processing modules 228. Included among the audio processing modules 228 are a text-to-speech (“TTS”) converter 230, an audio file player 232, and a speech recognition module 234. In operation, the telephony infrastructure 226 is responsible for detecting an incoming call from a telephony-based subscriber unit and for answering the call (e.g., by playing a predefined greeting). After a call from a telephony-based subscriber unit has been answered, the voice browser interpreter 200 assumes control of the dialogue with the telephony-based subscriber unit via the audio processing modules 228. In particular, audio requests from telephony-based subscriber units are parsed by the speech recognition module 234 and passed to the voice browser interpreter 200. Similarly, the voice browser interpreter 200 communicates information to telephony-based subscriber units through the text-to-speech converter 230. The telephony infrastructure 226 also receives audio signals from telephony-based subscriber units via the telecommunications network 120 in the form of DTMF signals. The telephony infrastructure 226 is able to detect and interpret the DTMF tones sent from telephony-based subscriber units. Interpreted DTMF tones are then transferred from the telephony infrastructure to the voice browser interpreter 200.

After the voice browser interpreter 200 has retrieved a VoiceXML document from the conversion server 150 in response to a request from a subscriber unit, the retrieved VoiceXML document forms the basis for the dialogue between the voice browser 110 and the requesting subscriber unit. In particular, text and audio file elements stored within the retrieved VoiceXML document are converted into audio streams in text-to-speech converter 230 and audio file player 232, respectively. When the request for content associated with these audio streams originated with a telephony-based subscriber unit, the streams are transferred to the telephony infrastructure 226 for adaptation and transmission via the telecommunications network 120 to such subscriber unit. In the case of requests for content from Internet-based subscriber units (e.g., the personal computer 106), the streams are adapted and transmitted by the network interface 310.

The voice browser interpreter 200 interprets each retrieved VoiceXML document in a manner analogous to the manner in which a standard Web browser interprets a visual markup language, such as HTML or WML. The voice browser interpreter 200, however, interprets scripts written in a speech markup language such as VoiceXML rather than a visual markup language. In a preferred embodiment the voice browser 110 may be realized using, consistent with the teachings herein, a voice browser licensed from, for example, Nuance Communications of Menlo Park, Calif.

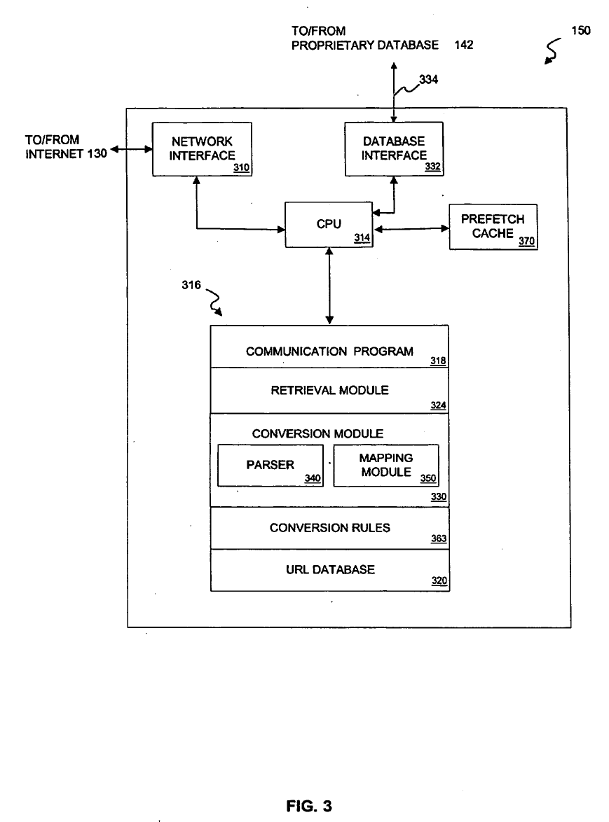

Turning now to FIG. 3, a functional block diagram is provided of the conversion server 150. In a preferred embodiment the conversion server is realized in accordance with the teachings of copending U.S. patent application Ser. No. ______, entitled DATA CONVERSION SERVER FOR VOICE BROWSING SYSTEM, which is hereby incorporated by reference in its entirety. In general, the conversion server operates to convert the content of various remote information sources into the format applicable to the voice browser 110. This conversion is effected by performing a predefined mapping of the syntactical elements of the content received from such remote sources into corresponding equivalent elements formatted in accordance with the protocol (e.g., VoiceXML) of the voice browser 110. Attributes associated with the syntactical elements of the retrieved content are also converted into the protocol of the voice browser 110.

The conversion server 150 may be physically implemented using a standard configuration of hardware elements including a CPU 314, a memory 316, and a network interface 310 operatively connected to the Internet 130. Similar to the voice browser 110, the memory 316 stores a standard communication program 318 to realize standard network communications via the Internet 130. In addition, the communication program 318 also controls communication occurring between the conversion server 150 and the proprietary database 142 by way of database interface 332. As is discussed below, the memory 316 also stores a set of computer programs to implement the content conversion process performed by the conversion module 150.

Referring to FIG. 3, the memory 316 includes a retrieval module 324 for controlling retrieval of content from Web servers 140 and proprietary database 142 in accordance with browsing requests received from the voice browser 110. In the case of requests for content from Web servers 140, such content is retrieved via network interface 310 from Web pages formatted in accordance with protocols particularly suited to portable, handheld or other devices having limited display capability (e.g., WML, Compact HTML, xHTML and HDML). As is discussed below, the locations or URLs of such specially formatted sites may be provided by the voice browser or may be stored within a URL database 320 of the conversion server 150. For example, if the voice browser 110 receives a request from a user of a subscriber unit for content from the “CNET” Web site, then the voice browser 110 may specify the URL for the version of the “CNET” site accessed by WAP-compliant devices (i.e., comprised of WML-formatted pages). Alternatively, the voice browser 110 could simply proffer a generic request for content from the “CNET” site to the conversion server 150, which in response would consult the URL database 320 to determine the URL of an appropriately formatted site serving “CNET” content.

The memory 316 of conversion server 150 also includes a conversion module 330 operative to convert the content collected under the direction of retrieval module 324 from Web servers 140 or the proprietary database 142 into corresponding VoiceXML documents. As is described in the above-referenced copending patent application, the retrieved content is parsed by a parser 340 of conversion module 330 in accordance with a document type definition (“DTD”) corresponding to the format of such content. For example, if the retrieved content is from a Web site formatted in WML, the parser 340 would parse the retrieved content using a DTD obtained from the applicable standards body, i.e., the Wireless Application Protocol Forum, Ltd. (www.wapforum.org). A mapping module 350 of the conversion module 330 then initiates the process of mapping, in accordance with predefined conversion rules 360, elements and attributes in the parsed file to corresponding equivalent elements and attributes conforming to the protocol of the voice browser 110. A converted document file (e.g., a VoiceXML document file) is then generated by supplementing these equivalent elements and attributes with grammatical terms when required by the protocol of the voice browser 110. This converted document file is then provided to the voice browser 110 via network interface 310 in response to the browsing request originally issued by the voice browser 110.

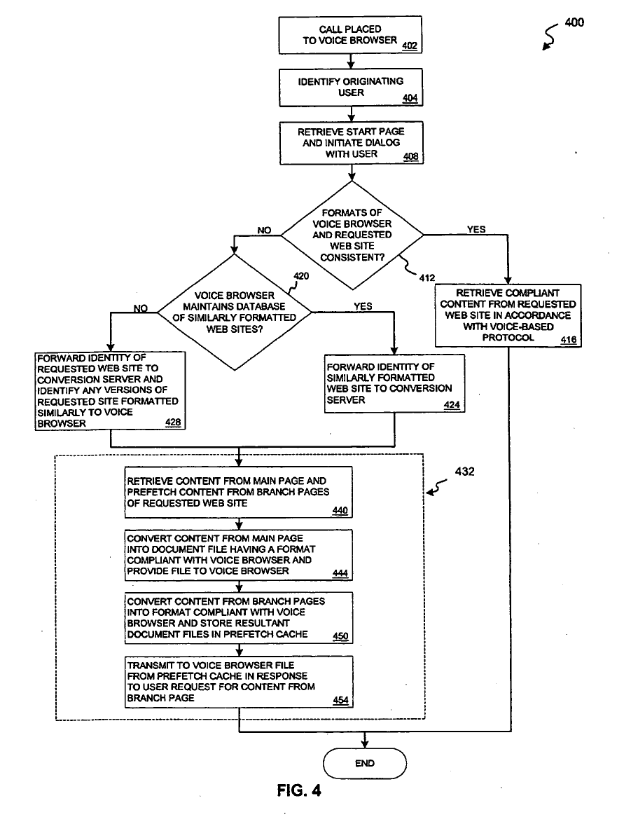

FIG. 4 is a flow chart representative of an exemplary process 400 executed by the system 100 in providing content from Web servers 140 to a user of a subscriber unit. At step 402, the user of the subscriber unit places a call to the voice browser 110, which will then typically identify the originating user utilizing known techniques (step 404). The voice browser then retrieves a start page associated with such user, and initiates execution of an introductory dialogue with the user such as, for example, the dialogue set forth below (step 408). In what follows the designation “C” identifies the phrases generated by the voice browser 110 and conveyed to the user's subscriber unit, and the designation “U” identifies the words spoken or actions taken by such user.
C: “Welcome home, please say the name of the Web site which you would like to access”
U: “CNET dot corn”
C: “Connecting, please wait . . . ”
C: “Welcome to CNET, please say one of: sports; weather; business; news; stock quotes”
U: “Sports”

The manner in which the system 100 processes and responds to user input during a dialogue such as the above will vary depending upon the characteristics of the voice browser 110. Referring again to FIG. 4, in a step 412 the voice browser checks to determine whether the requested Web site is of a format consistent with its own format (e.g., VoiceXML). If so, then the voice browser 110 may directly retrieve content from the Web server 140 hosting the requested Web site (e.g., “vxml.cnet.com”) in a manner consistent with the applicable voice-based protocol (step 416). If the format of the requested Web site (e.g., “cnet.com”) is inconsistent with the format of the voice browser 110, then the intelligence of the voice browser 110 influences the course of subsequent processing. Specifically, in the case where the voice browser 110 maintains a database (not shown) of Web sites having formats similar to its own (step 420), then the voice browser 110 forwards the identity of such similarly formatted site (e.g., “wap.cnet.com”) to the conversion server 150 via the Internet 130 in the manner described below (step 424). If such a database is not maintained by the voice browser 110, then in a step 428 the identity of the requested Web site itself (e.g., “cnet.com”) is similarly forwarded to the conversion server 150 via the Internet 130. In the latter case the conversion server 150 will recognize that the format of the requested Web site (e.g., HTML) is dissimilar from the protocol of the voice browser 110, and will then access the URL database 320 in order to determine whether there exists a version of the requested Web site of a format (e.g., WML) more easily convertible into the protocol of the voice browser 110. In this regard it has been found that display protocols adapted for the limited visual displays characteristic of handheld or portable devices (e.g., WAY, HDML, iMode, Compact HTML or XML) are most readily converted into generally accepted voice-based protocols (e.g., VoiceXML), and hence the URL database 320 will generally include the URLs of Web sites comporting with such protocols. Once the conversion server 150 has determined or been made aware of the identity of the requested Web site or of a corresponding Web site of a format more readily convertible to that of the voice browser 110, the conversion server 150 retrieves and converts Web content from such requested or similarly formatted site in the manner described in the above-referenced copending patent application (step 432).

In accordance with the invention, the voice-browser 110 is disposed to use substantially the same syntactical elements in requesting the conversion server 150 to obtain content from Web sites not formatted in conformance with the applicable voice-based protocol as are used in requesting content from Web sites compliant with the protocol of the voice browser 110. In the case where the voice browser 110 operates in accordance with the VoiceXML protocol, it may issue requests to Web servers 140 compliant with the VoiceXML protocol using, for example, the syntactical elements goto, choice, link and submit. As is described below, the voice browser 110 may be configured to request the conversion server 150 to obtain content from inconsistently formatted Web sites using these same syntactical elements. For example, the voice browser 110 could be configured to issue the following type of goto when requesting Web content through the conversion server 150:

<goto next=http://ConSeverAddress:port/Filename?URL=ContentAddress&Protocol/>

where the variable ConSeverAddress within the next attribute of the goto element is set to the IP address of the conversion server 150, the variable Filename is set to the name of a conversion script (e.g., conversion.jsp) stored on the conversion server 150, the variable ContentAddress is used to specify the destination URL (e.g., “wap.cnet.com”) of the Web server 140 of interest, and the variable Protocol identifies the format (e.g., WAP) of such content server. The conversion script is typically embodied in a file of conventional format (e.g., files of type “.jsp”, “.asp” or “.cgi”). Once this conversion script has been provided with this destination URL, Web content is retrieved from the applicable Web server 140 and converted by the conversion script into the VoiceXML format per the conversion process of the above-referenced copending patent application.

The voice browser 110 may also request Web content from the conversion server 150 using the choice element defined by the VoiceXML protocol. Consistent with the VoiceXML protocol, the choice element is utilized to define potential user responses to queries posed within a menu construct. In particular, the menu construct provides a mechanism for prompting a user to make a selection, with control over subsequent dialogue with the user being changed on the basis of the user's selection. The following is an exemplary call for Web content which could be issued by the voice browser 110 to the conversion server 150 using the choice element in a manner consistent with the invention:

<choice next=“http://ConSeverAddress:port/Conversion.jsp?URL=ContentAddress&Protocol/”>

The voice browser 110 may also request Web content from the conversion server 150 using the link element, which may be defined in a VoiceXML document as a child of the vxml or form constructs. An example of such a request based upon a link element is set forth below:

<link next=“Conversion.jsp?URL=ContentAddress&Protocol/”>

Finally, the submit element is similar to the goto element in that its execution results in procurement of a specified VoiceXML document. However, the submit element also enables an associated list of variables to be submitted to the identified Web server 140 by way of an HTTP GET or POST request. An exemplary request for Web content from the conversion server 150 using a submit expression is given below:

<submit next=“htttp://http://ConSeverAddress:port//Conversion.jsp?

URL=ContentAddress& Protocol method=””post” namelist=“site protocol”/>

where the method attribute of the submit element specifies whether an HTTP GET or POST method will be invoked, and where the namelist attribute identifies a site protocol variable forwarded to the conversion server 150. The site protocol variable is set to the formatting protocol applicable to the Web site specified by the ContentAddress variable.

As was mentioned above, the conversion server 150 operates to retrieve and convert Web content from the Web servers 140 in the manner described in the above-referenced copending patent application (step 432). This retrieval process preferably involves collecting Web content not only from a “root” or “main” page of the Web site of interest, but also involves “prefetching” content from “child” or “branch” pages likely to be accessed from such main page (step 440). In a preferred implementation the content of the retrieved main page is converted into a document file having a format consistent with that of the voice browser 110. This document file is then provided to the voice browser 110 over the Internet by the interface 310 of the conversion server 150, and forms the basis of the continuing dialogue between the voice browser 110 and the requesting user (step 444). The conversion server 150 also immediately converts the “prefectched” content from each branch page into the format utilized by the voice browser 110 and stores the resultant document files within a prefetch cache 370 (step 450). When a request for content from such a branch page is issued to the voice browser 110 through the subscriber unit of the requesting user, the voice browser 110 forwards the request in the above-described manner to the conversion server 150. The document file corresponding to the requested branch page is then retrieved from the prefetch cache 370 and provided to the voice browser 110 through the network interface 310. Upon being received by the voice browser 110, this document file is used in continuing a dialogue with the user of subscriber unit 102 (step 454). It follows that once the user has begun a dialogue with the voice browser 110 based upon the content of the main page of the requested Web site, such dialogue may continue substantially uninterrupted when a transitions is made to one of the prefetched branch pages of such site. This approach advantageously minimizes the delay exhibited by the system 100 in responding to subsequent user requests for content once a dialogue has been initiated.

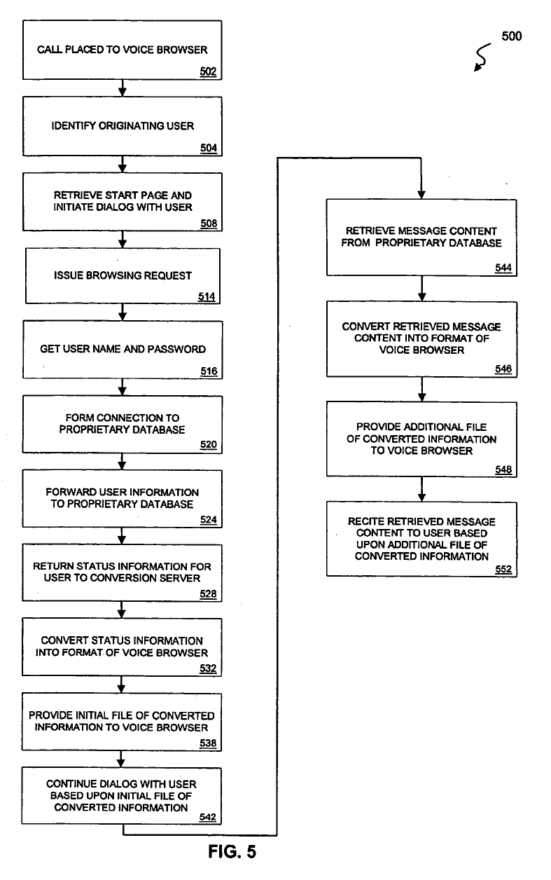

FIG. 5 is a flow chart representative of operation of the system 100 in providing content from proprietary database 142 to a user of a subscriber unit. In the exemplary process 500 represented by FIG. 5, the proprietary database 142 is assumed to comprise a message repository included within a text-based messaging system (e.g., an electronic mail system) compliant with the ARPA standard set forth in Requests for Comments (RFC) 822, which is entitled “RFC822: Standard for ARPA Internet Text Messages” and is available at, for example, www.w3.org/Protocols/rfc822/Overview.html. Referring to FIG. 5, at a step 502 a user of a subscriber unit places a call to the voice browser 110. The originating user is then identified by the voice browser 110 utilizing known techniques (step 504). The voice browser 110 then retrieves a start page associated with such user, and initiates execution of an introductory dialogue with the user such as, for example, the dialogue set forth below (step 508).
C: “What do you want to do?”
U: “Check Email”
C: “Please wait”

In response to the user's request to “Check Email”, the voice browser 110 issues a browsing request to the conversion server 150 in order to obtain information applicable to the requesting user from the proprietary database 142 (step 514). In the case where the voice browser 110 operates in accordance with the VoiceXML protocol, it issues such browsing request using the syntactical elements goto, choice, link and submit in a substantially similar manner as that described above with reference to FIG. 4. For example, the voice browser 110 could be configured to issue the following type of goto when requesting information from the proprietary database 142 through the conversion server 150:

<goto next=http://ConServerAddress:port/email.jsp?=ServerAddress &Protocol/>

where email.jsp is a program file stored within memory 316 of the conversion server 150, ServerAddress is a variable identifying the address of the proprietary database 142 (e.g., mail V-Enable.com), and Protocol is a variable identifying the format of the database 142 (e.g., POP3).

Upon receiving such a browsing request from the voice browser 110, the conversion server 150 initiates execution of the email.jsp program file. Under the direction of email.jsp, the conversion server 150 queries the voice browser 110 for the user name and password of the requesting user (step 516) and stores the returned user information UserInfo within memory 316. The program email.jsp then calls function EmailFromUser, which forms a connection to ServerAddress based upon the Transport Control Protocol (TCP) via dedicated communication link 334 (step 520). The function EmailFromUser then invokes the method CheckEmail and furnishes the parameters ServerAddress, Protocol, and UserInfo to such method during the invocation process. Upon being invoked, CheckEmail forwards UserInfo over communication link 334 to the proprietary database 142 in accordance with RFC 822 (step 524). In response, the proprietary database 142 returns status information (e.g., number of new messages) for the requesting user to the conversion server 150 (step 528). This status information is then converted by the conversion server 150 into a format consistent with the protocol of the voice browser 110 using techniques described in the above-referenced copending patent application (step 532). The resultant initial file of converted information is then provided to the voice browser 110 over the Internet by the network interface 310 of the conversion server 150 (step 538). Dialogue between the voice browser 110 and the user of the subscriber unit may then continue as follows based upon the initial file of converted information (step 542):
C: “You have 3 new messages”
C: “First message”

Upon forwarding the initial file of converted information to the voice browser 110, CheckEmail again forms a connection to the proprietary database 142 over dedicated communication link 334 and retrieves the content of the requesting user's new messages in accordance with RFC 822 (step 544). The retrieved message content is converted by the conversion server 150 into a format consistent with the protocol of the voice browser 110 using techniques described in the above-referenced copending patent application (step 546). The resultant additional file of converted information is then provided to the voice browser 110 over the Internet by the network interface 310 of the conversion server 150 (step 548). The voice browser 110 then recites the retrieved message content to the requesting user in accordance with the applicable voice-based protocol based upon the additional file of converted information (step 552):

Accordingly, a voice browser system including a subscriber unit in communication with a voice browser through a telecommunications network has been described herein. In response to requests for content from Web sites formatted in compliance with the protocol applicable to the voice browser, the voice browser obtains the requested content directly from the compliant Web site. When it is desired to obtain Web content formatted inconsistently with the voice browser, the voice browser issues a browsing request for such content to a conversion server using syntax substantially similar to that employed in making direct requests to compliant Web sites. That is, the voice browser is advantageously not required to operate in different modes when presented with requests for Web content of disparate formats. In response to browsing requests issued by the voice browser, the conversion server will attempt to identify a version of the requested Web site formatted in accordance with protocols suitable for serving content to devices having limited display capabilities (e.g., handheld or portable devices). The conversion server then preferably retrieves content from such a suitably formatted version of the requested Web site and converts this content into a document file compliant with the protocol of the voice browser. The converted document file is then provided by the conversion server to the voice browser, which uses this file to effect a dialogue conforming to the applicable protocol with the requesting user.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. A method for browsing the Internet comprising:
transmitting a first user request over a communication link to a voice browser, said voice browser operating in accordance with a voice-based protocol;
generating a browsing request in response to said first user request, said browsing request identifying a web server corresponding to said first user request;
retrieving web page information from said web server in accordance with said browsing request, said web page information being formatted in accordance with a predefined protocol;
converting at least a first portion of said web page information into a file of converted information formatted in compliance with said voice-based protocol; and
responding to said first user request on the basis of said file of converted information.

2. The method of claim 1 wherein said browsing request specifies an address of a conversion server, said conversion server establishing a communication channel with said voice browser upon receipt of said browsing request.

3. The method of claim 1 wherein said retrieving includes issuing a query to said web server in accordance with said browsing request, said query being formatted in accordance with a standard Internet protocol.

4. The method of claim 1 wherein said retrieving includes performing a branch traversal process by retrieving branched content from at least one first level branched page linked to a root page wherein content from said root page is included within said first portion of said web page information.

5. The method of claim 4 wherein said branch traversal process includes retrieving additional branched content from at least one second level branched page linked to said at least one first level branched page, said additional branched content being included within a second portion of said web page information.

6. The method of claim 4 further including
converting said second portion of said web page information into an additional file of converted information formatted in compliance with said voice-based protocol;
receiving at said voice browser a second user request corresponding to said branched content and responding to said second user request on the basis of information relating to said branched content included within said additional file of converted information.

7. The method of claim 6 wherein said first and second user requests are comprised of audio information

8. The method of claim 1 wherein said first user request identifies a first web site formatted inconsistently with said predefined protocol, said generating a browsing request including selecting a second web site comprising a version of said first web site formatted consistently with said predefined protocol.

9. A system for browsing the Internet comprising:
a voice browser operating in accordance with a voice-based protocol, said voice browser receiving a first user request transmitted over a communication link and generating a browsing request in response to said first user request; and
a conversion server in communication with said voice browser, said conversion server including
a retrieval module for retrieving web page information from a destination web site in accordance with said browsing request, said web page information being formatted in accordance with a predefined protocol;
a conversion module for converting at least a first portion of said web page information into a file of converted information compliant with said voice-based protocol; and
an interface for providing said file of converted information to said voice browser.

10. The system of claim 9 wherein said browsing request specifies an address of said conversion server, said conversion server establishing a communication channel with said voice browser upon receipt of said browsing request.

11. The system of claim 9 wherein said web page information includes branched content from at least one first level branched page linked to a root page, said retrieval module performing a branch traversal process by retrieving said branched content and content from said root page.

12. The system of claim 11 wherein said branch traversal process includes retrieving additional branched content from at least one second level branched page linked to said at least one first level branched page, said additional branched content being included within said web page information.

13. The system of claim 12 wherein a second portion of said web page information is converted into an additional file of converted information formatted in compliance with said voice-based protocol, said voice browser receiving a second user request corresponding to said branched content and responding to said second user request on the basis of information relating to said branched content included within said additional file of converted information.

14. The system of claim 9 wherein said conversion server further includes a database of web sites formatted in accordance with said predefined protocol and wherein said browsing request identifies a first web site formatted inconsistently with said predefined protocol, said retrieval module selecting said destination web site from said database wherein said destination web site comprises a version of said first web site formatted consistently with said predefined protocol.

15. A method for facilitating the retrieval of information through a voice browser operative in accordance with a voice-based protocol, said method comprising:
receiving a browsing request from said voice browser, said browsing request being issued by said voice browser in response to a first user request for content;
retrieving information from a remote information source in accordance with said browsing request, said information being formatted in accordance with a predefined protocol; and
converting said information into a file of converted information compliant with said voice-based protocol.

16. The method of claim 15 wherein said first user request identifies a first web site formatted inconsistently with said predefined protocol, said generating a browsing request including selecting said remote information source from a predefined set of protocol compliant web sites wherein said remote information source comprises a version of said first web site formatted consistently with said predefined protocol.

17. The method of claim 15 further including providing said file of converted information to said voice browser using standard Internet protocols.

18. The method of claim 15 wherein said browsing request identifies a conversion script, said conversion script executing upon receipt of said browsing request.

19. The method of claim 15 further including maintaining a database of web sites formatted in accordance with said predefined protocol wherein said browsing request identifies a first web site formatted inconsistently with said predefined protocol, said method further including selecting said remote information source from said database wherein said remote information source comprises a version of said first web site formatted consistently with said predefined protocol.

20. A method for retrieving content using a voice-based communication system comprising:
transmitting a first user request over a communication link to a voice browser, said voice browser operating in accordance with a voice-based protocol;
generating a browsing request in response to said first user request, said browsing request identifying a first remote information source corresponding to said first user request;
retrieving content from said first remote information source in accordance with said browsing request, said content being formatted in accordance with a predefined protocol;
converting said content into a file of converted information formatted in compliance with said voice-based protocol; and
responding to said first user request on the basis of said file of converted information.

21. The method of claim 20 wherein said browsing request specifies an address of a conversion server, said conversion server establishing a communication channel with said voice browser upon receipt of said browsing request.

22. The method of claim 20 wherein said first user request identifies a web site formatted inconsistently with said predefined protocol, said generating a browsing request including selecting a second web site as said first remote information source wherein said second web site is formatted consistently with said predefined protocol.

23. The method of claim 22 further including:
receiving at said voice browser a second user request corresponding to a second remote information source comprising a database formatted inconsistently with said voice-based protocol,
retrieving information from said database, and
converting said information into an additional file of converted information formatted in compliance with said voice-based protocol.
